(19) United States
(12) Patent Application Publication
(10) Pub. No.: US 2012/0007711 A1
(43) Pub. Date: Jan. 12, 2012

(54) Method, system, and apparatus for secure media checkout

(76) Inventor: Charles K. Lehnbeuter, St. Louis, MO (US)

(21) Appl. No.: 13/135,418

(22) Filed: Jul. 6, 2011

Related U.S. Application Data
(60) Provisional application No. 61/399,035, filed on Jul. 6, 2010.

(51) Int. Cl. G08B 29/00

(52) U.S. Cl. 340/5.6

(57) ABSTRACT

A method, system, and apparatus for secure media checkout of media contained within locked media cases that have information tags thereon identifying at least the media contained therein and the checkout status thereof, and specifically for controlling and effecting the unlocking of media cases presented for unlocking as part of a checkout process subsequent to a checkout match and recordation phase wherein media case matching occurs, utilizing a media case unlocking system that includes a media unlocking station or mechanism, a tag reader, such as a radio frequency identification transponder or bar code reader, a multicolor optical sensing array, a visual display, a microprocessor, and associated software, to control the media case unlocking phase of the checkout process and, preferably, to determine case type, case color, case position, and lock condition of the media case presented for unlocking.

### CROSS REFERENCE TO RELATED APPLICATION

This non-provisional application claims priority to and the benefit of Provisional Patent Application Ser. No. 61/399,035, filed Jul. 6, 2010, commonly owned by the same inventor.

### FIELD OF THE INVENTION

The method, system, and apparatus hereof relate generally to checkout of media from libraries or in a retail environment, and relate more particularly to provision of a secure method of self, or operator assisted, service checkout for secured digital media, operating either in a stand-alone mode or in an online environment, especially to the unlocking of media cases that contain smaller sized media therein.

### BACKGROUND OF THE INVENTION

Digital media circulation has increased dramatically in libraries over the past fifteen years. In some libraries, digital media, as opposed to written material, accounts for over one half of the library circulation. During this period, theft of digital media has become a major problem for libraries, especially because digital media, in general, often is of a small size, which has been decreasing, thereby making the media itself a tempting target for persons to remove from the library without following the proper checkout procedure. Theft of media by patrons or customers has become a major problem for libraries and retail outlets.

In such regard, theft has plagued merchants and retailers for centuries, and libraries from their starts. Retailers and libraries have their collections on display for viewing and handling by customers and patrons, who may select and carry with them merchandise and books, CDs, smaller media, and the like, so long as the merchandise and media remains within defined boundaries of the stores or libraries. The boundaries often include physical walls and increasingly include sensor arrangements usually located at entrances of retailers and libraries. Such sensors, which often make use of a magnetic field, generally are designed to trigger an alarm when merchandise or library material passes the sensors without a proper purchase or checkout.

One approach to the problem of digital media theft has been an attempt to deter theft by inserting the smaller sized digital media, with its packaging, into a larger lockable case and placing the larger lockable case, with the media inside, on the library shelf. The lockable case, which is larger and bulkier than the contained media, increases the difficulty of disguising or hiding it in clothing for surreptitious removal from a library. Generally, in the past, when a patron desired to check out a particular media, he/she was required to take the larger, locked media case, with the smaller sized media therein, to the library checkout desk where the librarian would unlock the case, remove the media, record its checkout, and deliver the media to the patron. The lockable case would remain at the library for reuse with various returned media.

In an effort to hold down operating costs and improve service levels, however, libraries have increasingly turned to patron “self check” solutions instead of continuing to rely upon librarians to perform the checkouts. In such regard, various patron self checkout systems have been developed to allow a patron, with limited or no assistance from a librarian, to check out a particular desired media. Such checkout systems have generally included or employed a checkout procedure that typically includes a checkout match and recordation phase during which information is recorded by the library associating the particular media presented by the patron with the patron, and generally establishing a return date for the media, and an unlocking phase in which the locked media case is then unlocked to permit removal of the media contained therein and the transport of such media by the patron.

In accordance with such systems, a patron is often permitted, after the checkout match and recordation phase, and without further assistance from or contact with a librarian, to unlock the larger, locked media case that contains the matched media so that such matched media can be removed and thereafter transported from the library by the patron. Unfortunately, with the known systems it is generally not possible to verify that only the particular locked media case that was actually presented by the patron during the checkout match and recordation phase is the locked media case that the patron then presents for unlocking and/or that the presented locked media case has the proper checkout status.

In some environments, especially “attended” or “partially attended” environments, this problem is ameliorated somewhat by the use of media cases and unlockers that have been designed to include additional features or provisions, including features that restrict or limit when and how a patron can attempt to unlock a case and/or features that allow one, including library staff and other patrons to more easily observe the lock status of a given media case.

In such regard, various media cases have been designed to include magnetic locking and unlocking features therewith. Known prior art unlocking devices or unlockers have therefore typically employed a channel and a magnet or magnets located at the bottom of the channel such that, when a patron places a locked media case in the channel, presumed to be the locked case containing the media of interest that is being checked out, the magnetic field from the magnet releases a latch locking the media case and/or holding the media in the locked case so that the patron can remove the media from the then-unlocked case and leave such unlocked case in a receptacle provided by the library for re-use by the library.

To prevent just anyone from using the library's case unlocking device, the channels of some unlockers include a physical obstruction that prevents insertion of a locked media case thereinto before a patron completes the checkout match and recordation phase of the checkout procedure. Removal of such obstruction may be effected under manual control by a librarian or under automated control by a system or computer that manages the checkout procedure.

With such media cases and unlocking devices, regardless of whether checkout is effected in an attended, partially attended, or self checkout environment, before the case can be unlocked, the patron must typically first approach the checkout desk with the locked media case and present a valid library identification card for checkout match and recordation purposes, whereupon a radio frequency identification (RFID) tag or a bar code tag, positioned or associated with the locked media case and the media contained therewithin, and which includes information identifying the particular media included within such locked media case, is scanned to identify the media selected for checkout.

Such tag, especially if it is an RFID tag, may be located anywhere convenient on the locked media case, on an interior container or packaging for the contained media, and/or on the contained media itself. The tag, if a bar code tag, may be similarly located.

Upon completion of the checkout match and recordation phase, such as by the recordation or entry of appropriate information by the library's checkout system, which may include a computer or like host device, to match the presented media with the patron, the patron, with the still-locked media case in hand, then places the still-locked media case into the unlocking channel of the unlocker, which has had its obstruction removed through solenoid or other mechanical action as part of the checkout operation. The magnet of the unlocker, being in close proximity to the lock/unlock trigger mechanism of the media case, then causes the case to unlock so that the patron may remove the media from the now-unlocked media case, deposit the unlocked case at a designated location, and depart the library.

A problem with such system, however, is that, upon completion of the checkout match and recordation phase and removal of the channel obstruction of the unlocker, the unlocker can operate to unlock any locked media case that may be placed in the channel, including a different media case than the locked media case that was presented for checkout in the checkout match and recordation phase. Consequently, an unscrupulous patron may be able in the checkout match and recordation phase to effect an association of the presented media of a low value with the patron presenting such media for checkout, which media is hereinafter sometimes referred to as checkout matched media, to thereafter switch locked media cases after such checkout match and recordation phase but before the unlocking phase so that the locked media case presented to the unlocker is a different media case than that presented during the checkout match and recordation phase, secure release during the unlocking phase of a different higher value media from the switched media case in place of the lower valued checkout matched media, and exit the library with the higher valued media instead of the lower valued checkout matched media.

This situation is especially problemsome with systems that are designed to operate in a self service mode, that is, without a librarian present during checkout. Because of such problems, libraries and retailers desire a device that can better guarantee that the media released by the unlocker of the system is the same checkout matched media actually presented for checkout. Such problem is sometimes hereinafter referred to as a match/unlocking problem.

Among the various media cases that have been developed in efforts to try to deter theft is a second, more complex media case that employs a sliding bar latch that is activated by at least two magnets at the bottom of a channel. Typically, the latch bar remains in the locked position using two or more magnetically sensitive metal pins. As the case is physically moved through the channel, the magnets attract the pins, and the latch bar is released, with the latch bar moving to the unlocked position as the pins move through the magnetic field. Such locking/unlocking mechanism technique provides a more secure lock because the magnets must have an exact spacing corresponding to the spacing between the pins, and the magnets must remain at that spacing as the case moves through the channel, but does not resolve the match/unlocking problem.

At least some of this type of media cases also includes features that allow one, such as a member of the library staff or a patron, to easily determine from an indicator associated with the media case the lock status of the media case. Not only does such lock status feature satisfy a desire of patrons to be able to confirm that a media case has successfully passed through an unlocker to unlock the case so that they can remove the checkout matched media from the case, but the visual lock status indicator also serves to enhance the security of many library checkout systems.

Typically, media cases employing such lock status feature have two printed images of a padlock located on or associated with the sliding bar of the locking mechanism such that, when the bar is in the locked position, an image of a locked padlock, often displayed in red or on a red background, is visible in a small window located near the center of and along an edge of the case and, when the bar is in the unlocked position, an image of an unlocked padlock, often displayed in green or on a green background, is visible in a small window located near the center of and along an edge of the case.

In attended or partially attended environments, library staff and patrons can readily observe whether the image is red or green to tell if a particular media case is then locked or unlocked, and may therefore be able to more readily detect when a patron has acted or is attempting to act improperly with respect to any given media case he/she is handling.

In the unattended environment, when it is even more critical to know the locked or unlocked status of media cases during and after the checkout process, especially in that an unscrupulous patron may have improperly unlocked a media case that included a higher valued media, substituted therein a lower priced media that he/she had removed from the media case presented for checkout, and left the now-unlocked media case with the now improperly matched case and media, ready detection of lock status is recognized to be a tool that can assist in the deterrence of media theft, even if it does not resolve the match/unlocking problem. Consequently, it has been recognized that it would be advantageous if unlockers could be designed and developed that would be responsive to such lock status colors and images, but such design and development has proven difficult and is complicated by many factors, including not only color recognition difficulties, but also difficulties due to the various case sizes for the various media types and the variations of color (shades of red and green) used to define the locked/unlocked indicators.

As a result of the difficulties related to color recognition, at least one system, as disclosed in Lax U.S. Pat. No. 7,415,851, has been developed that is operable to detect whether a lockable container case of a narrow width, such as a media case, is in a locked or unlocked condition. Such system includes an unlocker apparatus that has a main body with a lengthwise channel for receiving the container and a magnetic field that actuates a container lock catch partially within the container. The channel also includes a channel blocker, a ramp retractor, and a cam that prevent the field from actuating the catch in select situations. Such system utilizes a sensitive sticker, such as a highly reflective metal foil, placed over one of the lock symbols of the container, and the unlocker apparatus has detectors for the sticker to determine when the container is in an unlocked condition. Such apparatus lacks a color sensor, however, relying instead upon the sensitive sticker and detection thereof.

While such approach offers the advantage of being able to detect the lock status of media cases that may be fitted with such sensitive stickers, it is of limited value in that that it is ineffective for the millions of media cases already in libraries and retail outlets that do not have such sensitive stickers and which would require application of new stickers for the system to be usable therewith for lock status verification or determination. The cost and time for placement of new stickers over the locks for those existing cases would be, or approach being, prohibitive.

Libraries and retail locations therefore continue to be desirous of devices and systems that can detect the present lock symbols and readily determine the lock status of existing media cases at low cost and without the necessity for substantial retrofit.

Several other recent approaches to deterrence of digital media theft are of some interest and worthy of note, including the approaches disclosed in U.S. Patent Publication No. 2006/0116899 and in U.S. Pat. No. 7,380,711.

Simon U.S. Pat. No. 7,380,711 discloses a self checkout system and method that regulates checkout of digital media. The system utilizes magnetic and RFID tags having select frequencies, but such patent does not disclose use of optical signaling or sensing and does not resolve the match/unlocking problem.

Lax U.S. Patent Publication No. 2006/0116899 discloses apparatus and methods for processing items in a lockable container. A decoupler moves the container along a path that includes a magnetic field that inactivates or activates an EAS sensor. The decoupler may also communicate with an RFID tag upon the container. The apparatus also includes an optical circuit that is completed by a portion of the container as it moves along its path. Such optical circuit utilizes radiation in the infrared, ultraviolet, or visible light spectrum. The apparatus does not show magnetism moving a pin to unlock a container, however. The apparatus and its optical circuit can detect a specific pre-applied foil applied to the lock symbol, but cannot detect, in general, a red (locked) or green (unlocked) symbol from the various case manufacturers. Furthermore, the apparatus cannot detect the fact that the case has been inserted correctly, or which of the many case types has been inserted, and does not resolve the match/unlocking problem.

Consequently, although some of the more recent systems have made use of or included features that, in some ways, provide assistance in the deterrence of media theft, no known systems or approaches have been able to satisfactorily resolve the match/unlocking problem. The market has thus, until now, suffered from an unmet need for a system and method for authenticating a secured media case to verify the checkout match status of the media contained therein, checking for the condition of the lock status of such media case, unlocking the checkout matched secured media case, confirming that such media case has unlocked, and guiding a patron or customer through the process, in either an unattended environment or a clerk assisted environment. The present invention addresses such unmet demands and provides embodiments for several media case types.

### SUMMARY OF THE INVENTION

Generally, the present invention is a method, system, and apparatus for secure media checkout and specifically for controlling and effecting the unlocking of media cases presented for unlocking as part of a checkout process subsequent to a checkout match and recordation phase wherein media case matching occurs, typically deployed at libraries and retail locations. Embodiments in accordance with the present invention provide library or retail patrons with the ability to unlock a locked protective media case containing digital media, particularly in a self serve media case unlocking environment, while ensuring that the media case so unlocked is the checkout matched media case actually presented by the patron for checkout. The media within the protective media case has associated therewith, such as on or in readable tags on the media case, the media, or both, media identification information. Such identification tags preferably are or include RFID tags, bar coded tags, electromagnetic swipe strips, or the like, that serve to identify and authenticate the media within the protective media case and the checkout match status thereof, especially before the conduct of an unlocking operation to effect unlocking of the media case for removal of the media therefrom. Embodiments of the present invention provide a method for unlocking the proper checkout matched media case at the time of final checkout. The present invention thus provides for secure authorized unlocking of the appropriate media case at checkout, whether by a clerk or the self serve patron.

Preferably, the method and system of the present invention utilize a media unlocking station or mechanism, a tag reader, such as a radio frequency identification transponder or bar code reader, a multicolor optical sensing array, a visual display, a microprocessor, and associated software, to control, in whole or in part, the media case unlocking phase of the checkout process and, preferably, to determine case type, case color, case position, and lock condition of the media case presented for unlocking. Such method and system permit the provision of secure self service media case unlocking as part of the checkout process by a library or a secure purchase to process by a retailer of secured digital media in clerk assisted or unattended environments.

In some checkout environments, the librarian effects the checkout match and recordation phase of the checkout procedure for media in a presented, locked media case, as commonly known. During such checkout match and recordation, the patron places the presented, locked media case with the contained media on the checkout desk or at the checkout area within range of a tag reader, common examples of which may be or include RFID or bar code readers, and presents patron identification means or materials to the librarian.

The patron identification means or materials, sometimes hereinafter referred to as the patron identifier, may be so designed and have associated therewith various forms of identification indicia configured for use with cooperating systems. Some common patron identification materials are a library card or a driver's license, which identification materials may be or include a magnetic stripe card, a bar code card, or an RFID card.

The tag reader gathers the information about the item presented for checkout from the media information tag, or tags, on the case or the media, and the librarian submits the patron's identification materials to the library computer system, such as a member host, for approval, in order to record the appropriate information about the patron and to effect an association or correspondence between the presented media and such patron.

An RFID reader, or preferably, as will be further explained hereinafter, an RFID reader/writer, can be conveniently utilized as the tag reader when the tag associated with the media case and media is an RFID card to gather media information from the RFID tag and, if the patron identification materials include an RFID card, to also read the required information about the patron.

Once the system has all of the required information for checkout match and recordation, it effects an alteration of a media match indicator, such as a bit in the information field of the RFID on the locked media case to indicate completion of the checkout match and recordation and to identify that particular presented, locked media case as a media case whose media contents are approved for release and a media case that may thereafter be properly unlocked to complete the checkout process. By way of example, an RFID writer, or preferably the RFID reader/writer discussed previously, may operate to write to, or set, the media matched bit on the RFID tag and to signal to the librarian completion of checkout match and recordation.

The librarian then delivers the still-locked, but now media matched media case to the patron who proceeds to the unlocking station and places the locked media case, with the contained and now checkout matched media therein, into the unlocking station. The unlocking station detects insertion of the media case, reads the information from the RFID tag, including the set media matched bit, and sends the tag information to the host or library computer system. The host checks the information and notes the set matched media bit, which indicates that the media case is approved for unlocking. Then, the host commands the unlocking station to unlock such media case, allows the patron to remove the media from within the now-unlocked media case, and records the checkout of the media from the media case.

While the media match indicator will often be in the form of a settable bit, as described hereinabove, it may take other forms as well, including forms that may be received or detected by the media case unlocking system when the media matched media case is presented for unlocking. Typically, the media match indicator is established by altering information stored on the RFID tag or electromagnetic swipe tag disposed on the media case, but need not be limited to such types of alterations. By way of example, and not of limitation, such media match indicator may also be a signal as generated and available at or within the host when media matching is affected, as will be appreciated and understood by those skilled in the art.

Depending upon the case type with which the system is employed, upon detection of the insertion of the locked media case, the unlocking station may also determine the case type, detect that the case is positioned correctly (e.g., that the locking bar is in position rather than the hinge), and sense the condition of the lock (locked or unlocked).

In certain checkout environments, the unlocking system may be so designed and so connected to operate independently from the library host, or in a stand alone mode, but to be reliant upon the status of the matched media bit in determining whether an unlocking operation is authorized for the particular locked media case inserted into the unlocker and in effecting unlocking of such media case if the matched media bit is in a set condition. Such embodiment does not require a connection to a host because, during an earlier phase of the checkout procedure, the media matched bit was set or enabled.

In another type of checkout system environment, no librarian or clerk participates. In such a situation, a patron presents his library card to a card reader provided for identifying the patron. At the same time, the patron places the locked media case in the unlocking station. Information from the patron's card and from the media case is provided to a host where the host records the information from the patron card and the media tag. If the information from the patron's card and the media tag meets the checkout criteria, a media match is established by the host and the host signals the media case unlocking system that the media case is approved for unlocking. The media case unlocking system determines the case type, correct position of the sliding bar, and the lock condition, and provides such information to the host. The host then determines whether the case has successfully unlocked before signaling the patron to remove the case and the media from the unlocking station.

There has thus been outlined, rather broadly, the more important features of the invention in order that the detailed description thereof that follows may be better understood and that the present contribution to the art may be better appreciated. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the method, system, and apparatus for secure media checkout is to prevent exchanging higher value media for checked out lower value media in a self serve environment.

Another object of the method, system, and apparatus for secure media checkout is to eliminate fraud by patrons and customers.

Another object of the method, system, and apparatus for secure media checkout is to provide an apparatus that has a low cost of manufacturing so libraries, retailers, and government agencies can readily purchase the apparatus through dealers and supply sources.

These, together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter which illustrate several preferred embodiments of the invention.

### BRIEF DESCRIPTION OF THE DRAWINGS

In referring to the drawings:

FIG. 1 is a top view of one typed of existing media cases capable of being unlocked by the present invention, which media case employs a single magnetic member for locking the case;

FIGS. 2, 2a, 2b, and 2c, are top views of another type of existing security cases that employ a locking bar requiring two magnets for locking operations, and motions to successfully unlock the case;

FIG. 3 is a block diagram of the various components of the single magnet embodiment of the present invention; and,

FIGS. 4a and 4b are block diagrams of the various components of the multiple magnet embodiment of the present invention.

### DESCRIPTION OF THE PREFERRED EMBODIMENT

The present invention overcomes various difficulties experienced with the use of prior art systems by providing a method, system, and apparatus for controlling media case unlocking as part of a checkout process from locations such as libraries and retail locations. Such locations often have compact discs, digital video discs, and solid state devices including memory sticks, cassette tapes, long playing records, books, and magazines in their collections or for sale.

Libraries and retail sales establishments, to minimize operating costs, typically allow patrons and customers to select from the shelves digital media items such as CDs, DVDs, VHS tapes, audio tapes, or even smaller forms such as solid-state devices that can be inserted into a USB port and operate as an external memory sources. In years past, books, while sometimes objects of theft by unscrupulous patrons or even thieves, were, because of their relatively large sizes, less tempting targets than are the current smaller media items of substantial value serve as tempting targets for. Libraries and retailers often seek to reduce such temptation to steal the smaller digital media by placing them into larger, lockable media cases that prevent patrons from readily placing the smaller sized media into a pocket or bag. While such action serves to reduce theft, it also increases the difficulty experienced by honest patrons in gaining access to the smaller media and authorized removal thereof from the locked media case during the course of a checkout procedure.

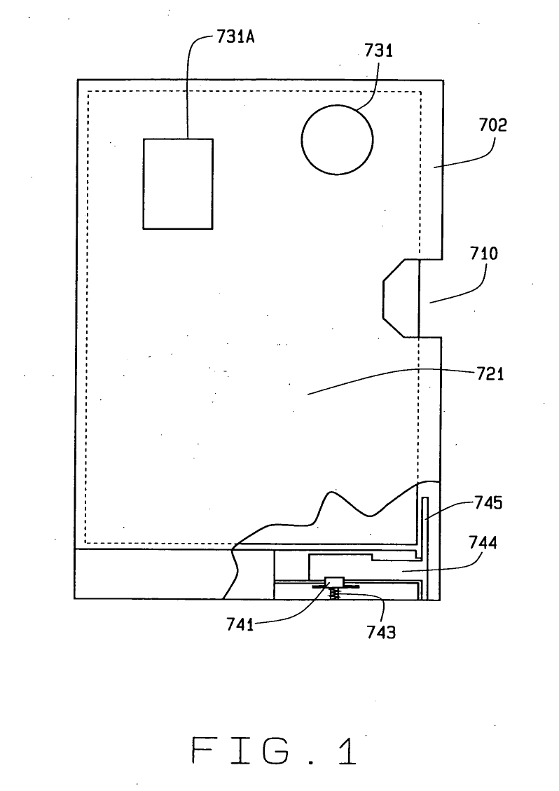

FIG. 1 depicts one common type of security or media case currently in use, sometimes hereinafter referred to as a type 1 case. A plastic case 702 houses a protected digital media 721. A media access area 710 allows for removal of the media after the unlocking of the case. However, when the existing case is in a locked condition or state, the media remains within the case because a stop 745 and a latch 744 remain locked in place by a pin 741. The pin 741 of a magnetically sensitive material keeps its position by a spring 743, locking the latch 744 and stop 745.

FIG. 1 shows a typical locking mechanism. Many variations of such depicted stop and latch for media cases may also be found present in the market and many others are possible and foreseeable.

The prior art cases of such type have the common principle that to release the latch and remove the media from the case, a magnet of sufficient strength must be placed below the pin so that the force from the magnet overcomes the spring tension and causes withdrawal of the magnetic pin 741 from the latch, thus allowing the latch and stop to slide with the media during its removal. When the security case is in the presence of the magnet, the case may thus be unlocked and the media therein may thus be removed therefrom.

The size of the pin and tension of the spring correlate to and require a magnet of an appropriate size and field intensity, not available from ordinary sources. Commonly available household, or even commercial magnets, do not have field intensity sufficient to release the pin. Additionally, the magnet requires a placement sufficiently close to the bottom of the case to produce the required force on the latch pin.

Information tags, such as FID tags, may be positioned anywhere on the protective case 731, the media 731A, or both. Such an information tag is so designed and configured to include thereon information about the media of interest, such as an inventory number, title, edition, and other identifying characteristics.

In addition, the tag may also include, at least for purposes of the present invention, information about the status of the media case, such as its checkout status and whether it is ready for unlocking, as will be further explained hereinafter.

In such regards, the tags are preferably of a type such that portions thereof may include information stored thereon in some fashion and wherein at least some of the stored information may be altered, such as by an RFID writer. Typically, as the media cases are recycled and re-used to contain different media, the RFID tags thereon are altered to include updated information on the new contents of the media case instead of the previous contents. The use of RFID writers for such purpose is well known and need not be further addressed herein.

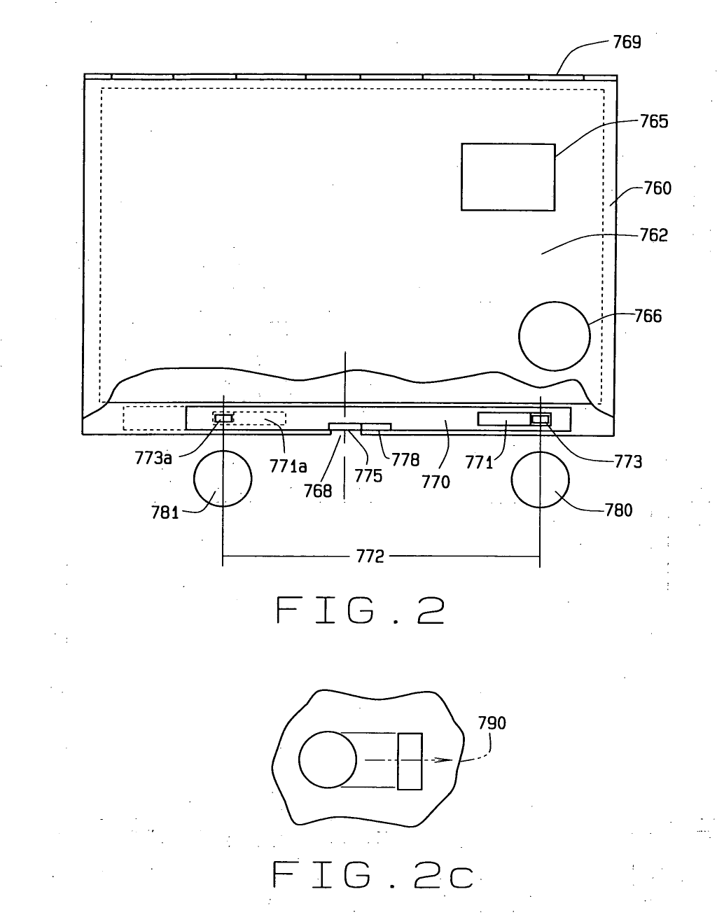

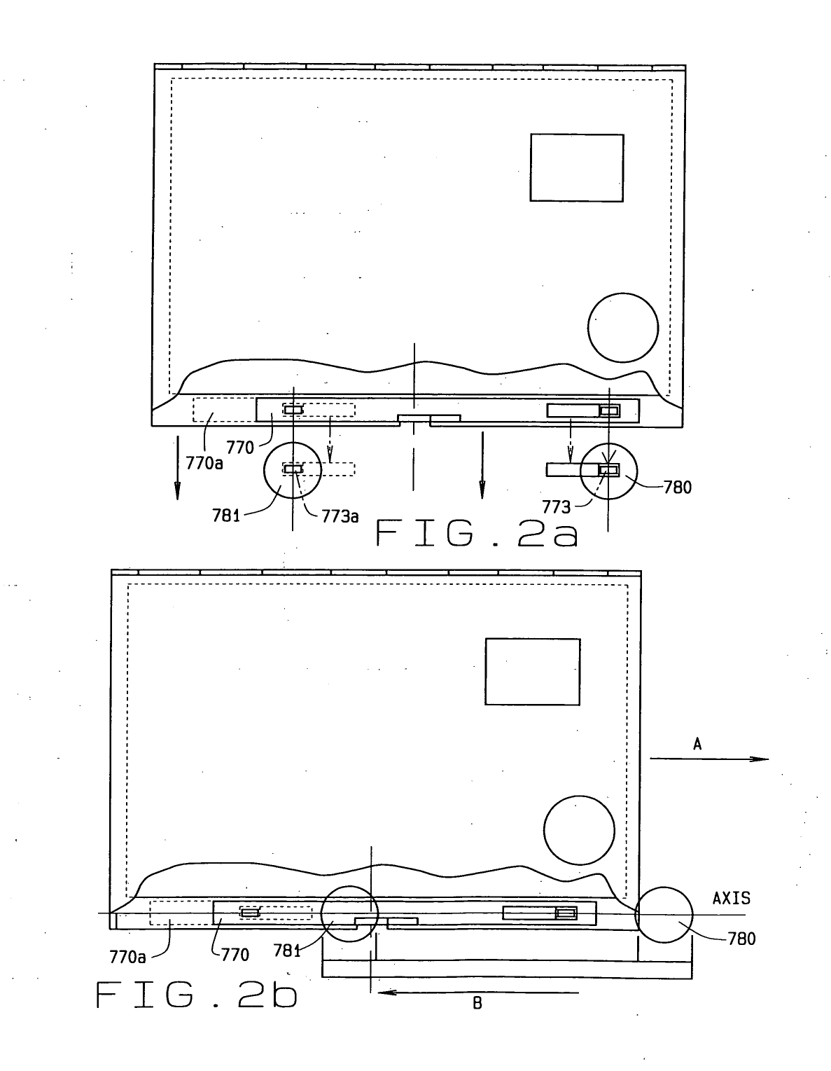

FIGS. 2, 2a, 2b, and 2c depict a second, common type of security case 760 currently in use, sometimes hereinafter referred to as a type 2 case. Cases of such type generally are formed of two halves that form and operate as a clamshell arrangement, hinged along one side 769. When closed, the clamshell is held closed by a latch/bar assembly that has a latch bar 770, two latch springs 771, 771a, one on each half of the clamshell, and two magnetically sensitive elements 773, 773a, attached to respective latch springs 771, 771a. The elements 773, 773a attach to the springs in such a manner that when these elements are in the presence of a magnetic field of the proper orientation and strength, the force of the magnetic field overcomes the spring force and allows for movement of the latch bar 770 to an unlock position so that the clamshell may be opened. Thus, unlocking of such type of case requires two magnets, placed at strategic locations on opposite sides of the existing case, as shown in FIGS. 2, 2a, 2b, and 2c.

The media 762, shown in FIG. 2, once again, is disposed and contained within protective media case 760. Information tags, preferably in the form of RFID tags, also have a position 765 on the case 760, a position on the media 766, or on both.

The proper orientation of the magnetic field to effect an unlocking of the latch of such type of cases is shown in FIG. 2c, as at 790, with the location of the magnets 772 along the latch bar 770 coinciding with the is location of the magnetically sensitive elements 773, 773a.

Simply lowering the existing case into a magnetic field such that the magnetically sensitive elements are in the presence of the magnetic field, as shown in FIG. 2a, does not completely unlock the locking bar, however. Such placement allows the latches to release the locking bar, but a mechanism must still be operated to move the latch bar to unlock the case.

To move the latch bar, relative motion must occur between the case 760 and the magnets 772 such that the latch bar 770 slides, while the magnetically sensitive elements 773, 773a remain in the magnetic field, to an open or unlocked position, as at 770a.

When an existing security case of such type is placed in an unlocker, the latch bar 770 will be moved in the proper direction because of the same magnetic field that holds the latch bar 770 open, as at 770a. Upon such placement, the magnetic sensitive elements 773, 773a, of the latch bar 770 are positioned into the magnetic field, and movement then provides relative motion between the case and the magnets.

The proper motion, as shown in FIG. 2b, positions the case so that the magnetically sensitive elements 773, 773a, follow the same axis as the magnets 780, 781, but at some distance from the magnets along that axis. Also as shown in FIG. 2b, the proper motion between the case and the magnets, that is, movement of the case in direction A or movement of the magnets in direction B, results in the latch bar 770 being unlatched and moved to the unlocked position as at 770a. The result of proper motion places the case in an unlocked condition at the end of the operation. The patron may then remove the now-unlocked case from the path of the magnets, open the clamshell case, and remove the media therefrom.

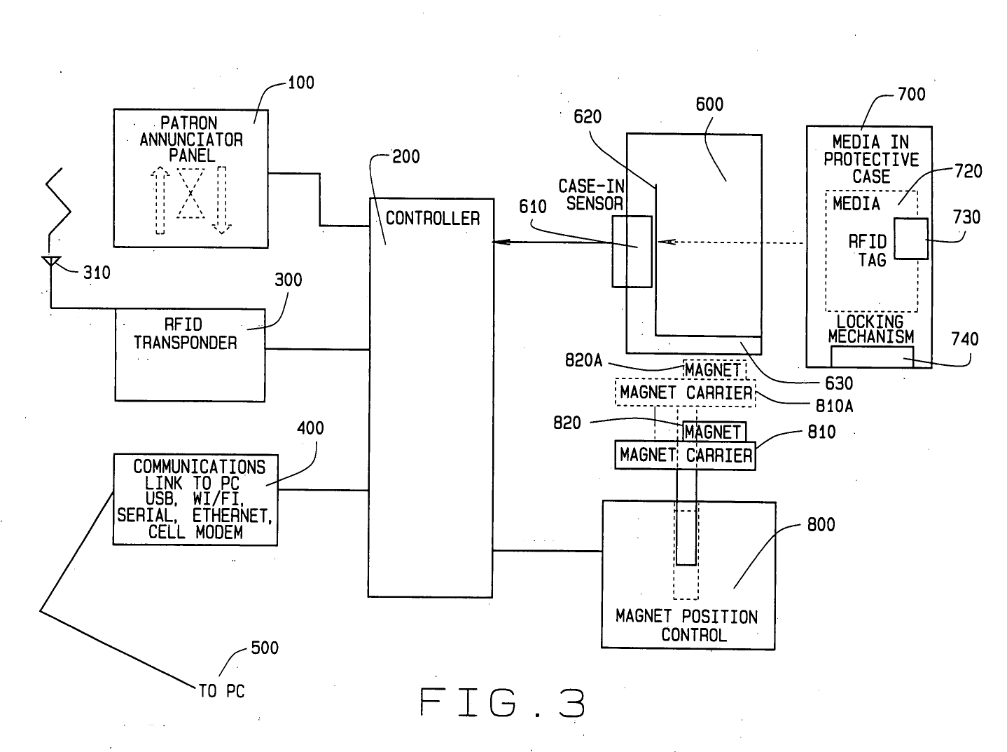

The latch bar 770 is also so designed to be able to indicate to the patron whether the case is in an open or unlocked state or condition or a closed or locked state or condition. In FIG. 2, at the center on the bottom edge of the case the edge has a window or opening 768 through which a picture of a padlock printed on the underside of the latch bar 770 is exposed. Preferably, two printed padlock images are positioned at spaced locations along the latch bar 770, one in red, as at 775, and the other in green, as at 776. As the latch bar 770 moves from the locked position to the unlocked position, the padlock image exposed through such window changes from the red image, to the green image, with red indicating that the case as locked, and green indicating that the case is unlocked. The present invention has been designed and developed to interact with media cases of both of such common types, as described above with reference to FIGS. 1-2c. In such regard, FIG. 3 is a block diagram illustrating one preferred media case unlocking system according to the present invention. The system embodiment of FIG. 3 includes a patron communication portion, designated as patron annunciator panel 100, a tag reader/writer, designated as RFID transponder 300 with an associated antenna 310, a communications link 400, a host system or computer 500, and an unlocking apparatus that includes a media case receiver or channel 600 and an associated magnet positioning control 800, interconnected generally as shown.

Typically, the host system or computer 500 is a library system or computer that is so designed and so operable to effect checkout match and recordation actions during the checkout match and recordation phase of the checkout procedure, consistent with the particular requirements established by the library, and communications link 400 is a communications link between such library system or computer and the controller 200 of the media checkout system.

In general, controller 200, which may often take the form of a programmed microprocessor, may be regarded as the controller for at least the media case unlocking portion of the checkout procedure, but, depending upon whether a librarian plays any role in the checkout procedure or the checkout procedure is a totally self check procedure, may also act as an overall controller, passing control to the library system or computer at various times, such as for checkout match and recordation. Dependent upon desires of individual libraries, controller 200 and other portions of the media case unlocking system, such as the RFID transponder portion 300, may also is be delegated tasks by the library system or computer during the checkout match and recordation phase, such as the initial reading of the RFID tag information during the checkout match and recordation phase, the communication of such information to the library host system or computer, and the subsequent setting of the matched media bit on the RFID tag at or near completion of the checkout match and recordation phase, which operations have already been explained hereinabove. On the other hand, if the media case unlocking portion of the checkout procedure is conducted at a location distant or remote from the location where the checkout match and recordation phase of the checkout procedure is conducted, the library may prefer to maintain the media case unlocking system as a system separate, or essentially separate, from the checkout match and recordation system, even if that results in some duplication of components between the two systems.

Regardless of whether a librarian plays any role in checkout or the checkout procedure is a self check procedure, controller 200 preferably acts, at least during the media case unlocking phase of checkout, to communicate with the patron annunciator panel 100, including to pass along to the patron annunciator panel 100 instructions to or information for patrons during the checkout recording and match phase of the checkout procedure, which instructions and information may be communicated to controller 200 from library host system of computer 500 over communications link 400.

The patron annunciator panel may take many forms, including many well known forms, and may include audio or visual communication apparatus of various forms for providing to patrons audio and/or visual prompts and messages, including messages advising as to present actions in process and prompts instructing patrons of actions to take in furtherance of the checkout procedure, and especially during the media case unlocking phase of the checkout procedure, as will be further addressed hereinafter.

The communications link 400 may also take many forms, including many well known forms that may include hardwired connections and/or wireless communications. Such communications link 400 may thus, by way of example and not of limitation, employ or make use of USB, WiFi, serial cable, Ethernet, cellular telephone, and Bluetooth technologies in the establishment and provision of communications between the library host system or computer 500 and the controller 200 of the media case unlocking system.

It should also be appreciated that, while in order for checkout of media to be effected both checkout match and recordation must occur and media case unlocking must occur, there need not necessarily be a direct or automated communications link between the library host system and the media case unlocking system, especially in instances where the library utilizes a librarian in a fully or partially attended checkout procedure. In such event, library personnel and actions thereby may be considered to be the communications link between what may be considered a stand-alone checkout match and recordation system and a stand-alone media case unlocking system.

In any event, in accordance with FIG. 3, a patron, having in his hand a locked security or media case 700 and the media 720 contained therewithin, and having completed the checkout match and recordation phase of the checkout procedure so as to establish the media 720 as the checkout matched media in the checkout matched media case 700, such as by the writing of a set bit on the RFID tag 730 on the media case 700, as has previously been explained hereinabove, is ready to remove the media from the media case 700. In such embodiment of the system and the unlocking mechanism formed by channel 600 and magnet position control 800, channel 600 is provided as a location into which the patron inserts the checkout matched media case 700 to effect unlocking of such checkout matched media case 700 so that the checkout matched media 720 may be removed therefrom. Such channel 600 has stops 620 and 630 that serve to position the case correctly in channel 600.

Preferably, following completion of the checkout match and recordation phase of the checkout procedure, during which phase the set bit designating that the presented media case is a media matched media case, the library host system or computer, or the an attending librarian, communicates to controller 200 an indication or information in response to which patron annunciator panel 100 provides or makes available to the patron a communication or message, such as by motion lighting on annunciator panel 100, instructing the patron to insert the case into the channel, such as by a display arrow directing the patron to insert the case into the channel. Preferably, for visual signals and/or messages, the patron annunciator panel 100 will employ light emitting diodes or, alternatively, back lit liquid crystal display, fluorescent bulbs, or incandescent bulbs, although any other devices, apparati, or technologies that can effect the desired effect could be equally as well employed.

Once the media case 700 is inserted into channel 600 and is in position against the stops 620, 630, a case-in sensor 610 detects that the media case 700 is properly seated in channel 600 and signals controller 200 that a media case is present. Controller 200 then provides a signal or information to the patron annunciator panel 100 to effect generation of a display to indicate to the patron the processing of the media case. Typically, an indication advising the patron that processing is occurring and that the patron should await further communications appears to the patron by light motion within an hourglass figure at a display portion of the patron annunciator panel.

Upon such detection of the presence of the media case 700 in the channel 600, controller 200 also activates the RFID transponder 300, which has an antenna 310 positioned close to the side of the case 720 as it sits within the channel 600. The RFID transponder 300 produces a signal that activates the RFID tag 730 on the case or, alternatively, the media 720. A signal indicative of the interaction of tag 730 with such radio signal is communicated to controller 200, which checks the information received to verify the validity of the tag information. Dependent upon the mode of operation, controller 200 may send the valid tag information to host 500, such as a computer, through a communications link 400, or may process the tag information locally and make a decision as to whether to unlock the case or not.

If, upon checking the tag data, either the host 500 or the local controller 200 decides to unlock the media case, controller 200 signals the magnet position control 800. The magnet position control 800 includes a magnet 820 of sufficient strength to release the pin of a type 1 case, as described hereinabove relative to FIG. 1, when positioned at a proper distance from the case, as well as a magnet carrier or holder 810 and a mechanism to move the assembly of the magnet 820 and the carrier 810. In the home position, the magnet position control 800 maintains the magnet 820 and carrier 810 at a distance from the lower case stop 630, such as at the lower position shown in FIG. 3 where the magnet is identified as 820, such that the magnet is too far from the case bottom to effect movement of the magnetically sensitive pin in the case locking mechanism 740 and has little if any effect upon such magnetically sensitive pin.

If and when the controller 200, or the host 500 within operative communication with controller 200, determines to unlock the media case, the controller 200 causes the magnet position control 800 to raise the magnet 820 to an upper position, as at 820A. When the magnet is moved to such upper position, the magnet is spaced from the bottom of the case, more particularly, from the lower stop 630, such that the pin 741 in the locking mechanism, as previously discussed relative to FIG. 1, releases the case stops 744, 745 and unlocks the media case.

The patron may then remove the unlocked media case from channel 600 and the contained media from the unlocked media case. Upon such removal of the media case from channel 600, detectable by a change in state of the case-in sensor 610, the patron preferably receives further instructions, through the display on the patron annunciator panel 100, to place the emptied media case in the used case depository. The removal of the media case from the unlocking mechanism also signals the controller 200 through the case in sensor 610 to effect a lowering of 820 the magnet to the home position and to prepare for the next media case to be presented.

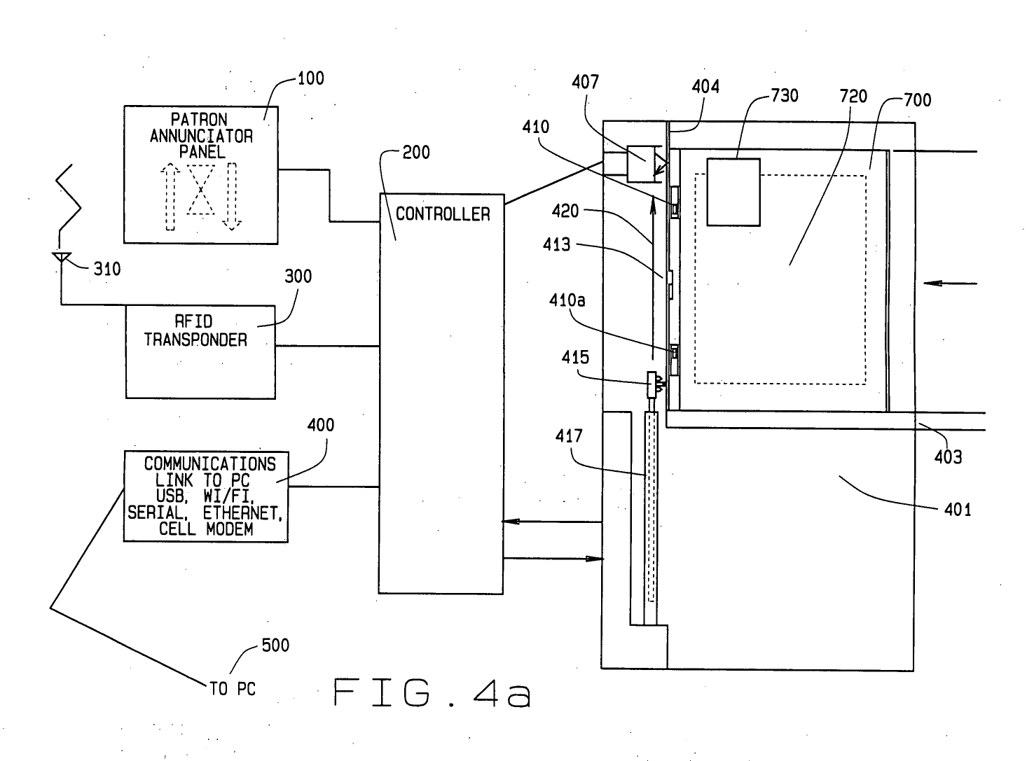

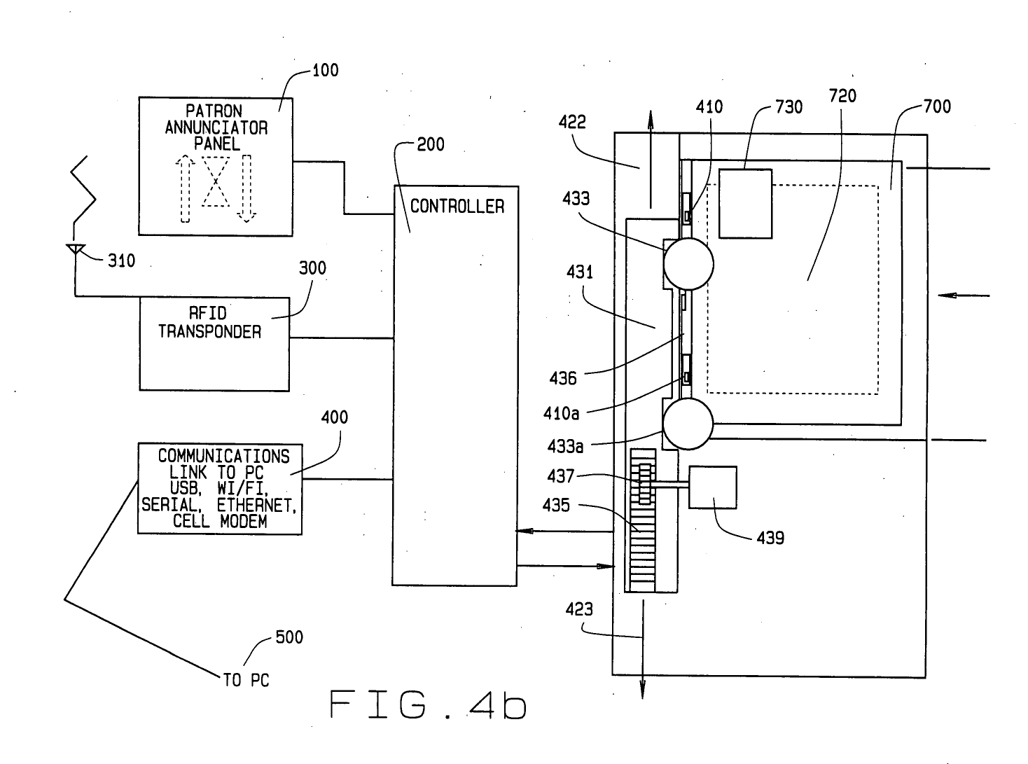

FIGS. 4a and 4b, when viewed together, illustrate another media case unlocking system that is designed as an exemplary unlocking system for the existing security case of the type previously described in FIGS. 2-2c, that is, for type 2 security cases. Significantly, the media case unlocking system embodiment of FIGS. 4a-4b offers various advantages not realizable with the media case unlocking embodiment of FIG. 3, as will become apparent from that which follows.

With the media case unlocking system of FIGS. 4a-4b, the patron receives instructions, similar to instructions received when the FIG. 3 embodiment is employed, to insert the case into the unlocking mechanism, here noted, as in FIG. 4a, as channel 403 in the housing 401. The patron annunciator panel 100 signals that the unlocking station or mechanism, sometimes hereinafter referred to as a detacher, is ready to receive a secure case, typically by displaying a lighted arrow indicating the case can be inserted. The patron annunciator panel 100 may also display a further instruction indicating that the case should be inserted into the channel of the detacher with the locking bar 436 inserted first.

At such point, the patron inserts the case until it reaches the stop 404, and then releases the case. A case-in sensor 407 detects that a case has reached the in position and signals the controller 200 to begin the sequence ultimately leading to the unlocking of the case. The case-in sensor 407 may include a mechanical switch, optical sensors, or like devices, although FIG. 4a shows the preferable use of a reflective optical sensor.

Upon detection of a case within the detacher, the controller 200 effects a change in the display by the patron annunciator panel 100 to cause an hourglass to be displayed, indicating that media case unlocking has commenced. At the same time, the controller 200 initiates a process to determine (1) if the case has actually been properly inserted with the latching bar forward as instructed; (2) the case type and size so that the lock position may be determined; and (3) the case background color.

It should be recalled from the discussion of the type 2 case as presented hereinabove relative to FIGS. 2-2c that such type media cases have lock indicators of different colors along edges that become visible depending upon the position of a locking bar and whether the locking bar is in a locked or unlocked position. As has been explained, it is desirable to be able to readily determine, preferably from an examination of such lock indicators, the lock status of the media cases.

In such regard, it should be recognized and understood that proper recognition of the colored lock indicators is not a simple matter. It is necessary to determine the background color of the case so that the lock/unlock condition of the case can thereafter be properly and effectively determined. The background for the lock symbol and the shades of red and/or green used by the various case manufacturers vary greatly, as these were designed to be detected by the human eye.

While it is relatively easy for the human eye to determine the color of the symbol in the lock area, the human eye does not act as an absolute color detector, but depends on a much more complex algorithm involving three factors: hue, saturation, and luminance. Unfortunately, electrical sensors that detect color are typically sensitive to three basic colors, red, green, and blue, with a great deal of overlap. These sensors are not single frequency detectors, but rather have a maximum output at the frequency of red, green, or blue. In other words, the red sensor will have some output for colors approaching green or even blue, while the green sensor has output well into both the red and blue color range. It is therefore not possible to use the outputs directly from these sensors to reliably distinguish the red or green lock symbol on all backgrounds and for all cases. However, by measuring the RGB components at various brightness levels, it is possible to convert these readings into the three factors of hue, saturation, and luminance (HSL), and, from such information, to determine whether the symbol on the background is red (signifying that the case is locked) or green (signifying that the case is unlocked).

The embodiment of FIGS. 4a-4b employs an array of optical emitters and detectors to determine that the media case has been inserted properly, the position of the lock symbol, and the condition of the lock symbol (locked or unlocked). Specifically, in the embodiment of FIGS. 4a-4b, the optical array comprises a fixed position, infrared emitter and reflective sensor 407, and a movable color sensor 415, sometimes hereinafter referred to as a color sensor array, with a visible light emitter.

Upon insertion of the media case 720 into the channel 403, the fixed sensor 407 detects reflected infrared energy from the media case edge closest to the sensor. This information indicates only that a case has been inserted. To check to see that the case has been inserted properly (i.e., locking bar first), a microprocessor type controller 200 causes a series of high energy pulses to be emitted by the infrared emitter of the fixed part of the array 407. The energy from these pulses is absorbed by the material directly in front of the emitter. Since the media case edge with the locking bar and the media case edge opposite the locking bar are comprised of different materials, or thickness of material, or both, it can be determined by measuring the decay time of the reflected energy return if the case is positioned with the locking bar in first (the correct position).

If it is determined that the case is not inserted properly, the patron is preferably notified by the patron annunciator panel 100 that the media case must be removed and properly re-inserted.

Once it is determined that the media case has been inserted properly, microprocessor 200 begins the process of determining the media case type/size. This is accomplished using the movable color sensor array 415, sometimes referred to hereinafter as the light-color sensor or the light/sensor assembly, which is attached to a linear actuator 417. Microprocessor 200 signals the linear actuator 417 to move the light-color sensor 415 along the edge of the locking bar 436 in the direction of the arrow 420. During movement of the light/sensor assembly, microprocessor 200 receives color samples as a series of readings is taken along the edge of the inserted media case. Microprocessor 200 moves the color sensor array 415 a distance “x” using the linear actuator 417, takes a reading, moves “y” and takes another reading, etc. These readings are compared with recorded readings made during calibration of the detector at time of manufacture. Each case/background color provides a unique “signature”, and when readings from the inserted case are compared with all made during calibration, a match will determine the case type/background color.

As new cases are added by the industry, a simple calibration procedure can be used to provide the recorded information necessary to identify and unlock the new cases.

At such point in the unlocking process, then, it will have been determined that the media case is inserted properly, and the media case type will be known. Since the type of media case is known, the position of the lock symbol 413 along the media case edge for such media case type will also known. (For existing media cases the symbol has consistently been at the midpoint along the locking bar, although, in the future, it is possible that the symbol, for a given media case type, could be located in a different position along the locking bar). Microprocessor controller 200 next moves the color array 415, using the linear actuator 417, to a position along the locking bar where the lock symbol 413 will be for the media case type that has been inserted.

Several readings are then taken in the general vicinity of the lock symbol position. The visible emitter of the color sensor 415 is pulsed with intensity consistent with the background color of the case.

It is necessary to vary the intensity dependent upon the background color of the media case since the reflected light from the lock symbol area is a combination of colors from the background of the media case and from the lock symbol itself. If a constant light intensity were to be used, the background reflection may saturate the individual color sensors. It now becomes apparent as to why one needs to know the background color/and type of case. The RGB readings (readings taken directly from the red, green, and blue sensors) are converted by the microprocessor 200 to HSL data. From such HSL data, the microprocessor 200 then determines if the lock is symbol is red (locked), or green (unlocked).

Even though the case, at this stage of the media case unlocking phase, should have a red, or locked status, it is possible that a library clerk or patron may have inadvertently unlocked such media case and/or left it unlocked, without notice by other people. In such event, the remainder of the unlock cycle is not necessary, and the patron annunciator panel 100 may notify the patron, such as by appropriate lighting, to then remove the case and retrieve the media from the case.

Inasmuch as, during the size and lock determination process, the RFID tag 720 associated with the media case 700 has a position proximate the antenna 310 in the field of transponder 300, information about the media contained in the media case 700 is available to be conveniently read and re-transmitted to the host computer 500, dependent upon the mode of operation of the media case unlocking system. In the situation where the presented media case is determined to be an inadvertently unlocked media case, if the microprocessor 200 is in electronic communication with the host computer 500, such information is transmitted to the host computer 500, but if the unlocking system is operating in stand-alone mode and engaging in local offline decision-making, such information is retained by microprocessor 200 and is not transmitted to the host computer 500.

Generally, however, presentation of an inadvertently unlocked media case during the media case unlocking phase of checkout is not the expected determination at such point in the media case unlocking process.

Consequently, the movement of the color sensor 415 to the window area of the media case typically finds the lock symbol to have a red color, indicating that such presented media case is locked. In such event, microprocessor 200, having found a locked media case, reads the information contained in the RFID tag, and either using the communications link 400 to the host 500, for a networked system, or locally, using the set bit as an indicator, effects initiation of the actual media case unlocking operations.

Upon confirmation that the set bit of the RFID tag 720 identifies the presented media case as a media matched media case having checkout matched media therein, the media case unlocking system is then ready to unlock the presented media case. At such time, microprocessor 200 effects operation of magnet position control that includes a motor 439, as best shown in FIG. 4b. Energization of motor 439 results in a rotary motion by such motor that is converted to a linear movement of the magnets 433, 433a past the magnetically sensitive elements 410, 410a in the lock bar, using a gear 437 and rack 435 arrangement associated with a movable member 431, as shown in FIG. 4b.

FIG. 4b serves as an illustrative example of one manner in which magnets 433, 433a can be positioned and moved to effect operation of the magnetically sensitive elements 410, 410a and the locking bar 436, but it should be appreciated that many other manners of effecting such an operation can also be realized and that a variety of approaches and mechanisms, including not only existing approaches and mechanisms but also approaches and mechanisms not yet developed, could be advantageously employed to achieve the desired result.

With the particular embodiment of FIGS. 4a-4b, as the magnets 433, 433a are caused to move past the magnetically sensitive elements 410, 410a by operation of motor 439, the lock bar 436 moves in a direction, shown in FIG. 4b as an upper direction, as indicated by the arrow 422.

If the media case was properly inserted (i.e., with the locking bar first) into the channel 404 of the unlocking station of the media case unlocking system by the patron with a correct orientation of the media case, the media case should then be unlocked. However, if the patron placed the media case into channel 404 incorrectly, upside down, top to bottom, or bottom to top, the media case will remain locked at this stage of the process.

By making use of the color sensor 415 of FIG. 4a to check the color of the lock symbol in the case window 413 at such time, microprocessor 200 can effectively determine whether the media case has unlocked or remains locked, such as due to incorrect initial orientation of the media case in channel 404.

If the color of the lock symbol remains red, microprocessor 200 determines that the media case remains locked and that it was placed in the channel 404 in an inverted condition. In such event, microprocessor effects reverse operation of motor 439 to effect movement of movable member 431 and the associated magnets 433, 433a in the direction of arrow 423, shown to be downward in FIG. 4b, to the home position therefor, and positions color sensor 415 to again check the color of the lock symbol in the window of the lock status window of the media case. The reverse movement of magnets 433, 433a in the direction of arrow 423 will have pulled the magnetically sensitive elements 410, 410a along therewith and moved locking bar 436 in the direction of arrow 423 to unlock the incorrectly oriented media case and to place the green lock symbol into the window of the media case. Consequently, upon operation of color sensor 415 to again check the color of the lock symbol in the window of the lock status window of the media case, the incorrectly oriented media case should then be unlocked.

When microprocessor 200 successfully determines that the lock symbol for either a properly oriented or improperly oriented media case has a green color and the media case is unlocked, an indication and/or message will preferably be generated by the media case unlocking system, such as by display thereof on patron annunciator panel 100 under control of microprocessor 200 informing the patron that the media case is unlocked and that such case can be removed from the media case unlocking system and the media in such media case can be retrieved therefrom.

Following removal of the unlocked media case from the unlocking station of the media case unlocking system, which may be detected from a change in the state of case-in sensor 407, as best shown in FIG. 4a, microprocessor 200 may signal motor 439 to operate to, if necessary, move movable member 431 and associated magnets 433, 433a in the direction of arrow 423 to return such elements to the home position if such elements are not already there, such as is indicated on FIG. 4b, in preparation for the next media case that will be inserted into channel 404 of the unlocking station of the media case unlocking system.

Regardless of the particular embodiment of the invention utilized and the media case presented for unlocking therewith, if the controller of the media case unlocking system, or the host, detect that the media case presented for unlocking is not a media case that is authorized to be unlocked, such as because the set bit on the RFID tag of the media case does not show that media case to be a media matched media case containing checkout matched media, further unlocking actions by the media case unlocking system will typically be terminated and the system may effect production of indications on the patron annunciator panel advising the patron that that the media case presented is not authorized to be unlocked. Depending upon desires of the library, detection of such an unauthorized media case could result in a lockup of the unlocking station of the media case unlocking system, a notification message from the media case unlocking system to the host, and/or activation of an alarm.

In the foregoing there has thus been disclosed a method to unlock a media case that contains media after such media case has completed the checkout match and recordation phase of a checkout process. Generally, the media case may have an identification tag upon it and at least one locking pin designed to be operated by at least one movable magnet in an unlocking apparatus. The method detects the presence of the media case, and may abort the unlocking process if the media case is not detected at some later point in the unlocking process. The method then reads the identification tag associated with the media case and, if the identification tag indicates that the media case is a media case that was presented and approved for unlocking during a checkout match and recordation phase of the checkout process, effects an unlocking of the case, but if the identification tag indicates that the media case has not been approved for unlocking during a checkout match and recordation phase, leaves the case locked. Preferably, during the performance of such steps, the method advises the user about the disposition of the media case and the unlocking process, typically by a lighted annunciator panel. The method effects unlocking of a media case approved for unlocking by moving a magnet horizontally or vertically such that the magnet operates to pull a locking pin to unlock the case. Alternatively, the method could employ an electromagnet where activation of the electromagnet, in a preset position, pulls a locking pin to unlock the case.

There has also been disclosed a media case unlocking system for secure checkout of media from a source, such as a library or a retail store, which begins with an existing locked, media case. One common type of media cases typically has a perimeter, two halves joining upon a living hinge, with at least one of the halves having magnetic materials thereon that rest within a carrier that moves upon a portion of the perimeter of the case opposite the hinge to lock and unlock the media case, and wherein the carrier has at least one colored indicator detectable outside of the media case and an RFID or like identification tag thereon used to provide at least identification information regarding media contained within the media case and checkout status information thereabout. The media case unlocking system includes an unlocking station with a holder that receives the case, opposite the hinge, where a sensor detects the presence of the case, an RFID transponder for interacting with the RFID tag on the media case, a second sensor for detecting whether the case is unlocked, a magnet position control with magnetic elements positionable to interact with the magnetic materials of the media case to effect unlocking of the media case, and, a controller in communication with the sensors, the RFID transponder, and the magnet position control. The controller preferably also connects to an external host, or computer, upon an electronic network, and to a patron annunciator panel which it controls and operates to communicate to a patron certain information. The second sensor typically operates in the visible light spectrum, preferably in the red and green light wavelengths, and generally includes a light detector having a plurality of nodes, wherein each node includes a red detector, a green detector, and a blue detector positioned is adjacent one another. The nodes of the detector determine the amounts of red, green, and blue light falling thereupon, with the second sensor calculating the dominant color of light present from the maximums values of each subsidiary color detector. The second sensor recognizes that incident light, of a dominant color, also includes a lesser portion of minor colors, and, based upon the information from the nodes, provides color information to the controller. In an alternative embodiment, the media case unlocking system may include a mechanized color chart that advances in view of the second sensor, with the color chart thus providing a reference color to the second sensor for comparison to incident light. The controller also regulates locking and unlocking of the case when placed in the holder using information from the sensor, the magnet position control, and the second sensor so that media that has not been checkout matched during a checkout match and recordation phase of a checkout process can be removed from a locked media case in substitution for another media that has been checkout matched.

Although RFID has been described hereinabove as an acceptable and preferred form of technology for the information tags employed on or with the media cases, the present invention may also utilize or operate with information tags based upon other technologies, including bar code and electromagnetic stripe technologies. During usage with a bar code system, the present invention typically requires communication with a host computer system.

From the aforementioned description, a method, system, and apparatus for secure media checkout have been described. The method is uniquely capable of locking and unlocking media cases containing media therein and checking the lock status of a case utilizing machine sensing of colors upon the case. The method, system, and apparatus, and the various components thereof, may be deployed upon various computer systems in a clerk controlled or self serve situation, and may be manufactured from many materials, including but not limited to, wood, steel, aluminum, polymers, polyvinyl chloride, high density polyethylene, polypropylene, ferrous and is non-ferrous metals, their alloys, and composites, and open and closed cell foams.

As such, those skilled in the art will appreciate that the conception, upon which this disclosure is based, may readily be utilized as a basis for the designing of other structures, methods, systems, and apparati for carrying out the several purposes of the present invention. Heretofore, those skilled in the art have not recognized a microprocessor that receives signals from a color sensor detecting the locked or unlocked status of a media case. Therefore, the claims include such equivalent constructions insofar as they do not depart from the spirit and the scope of the present invention.

I claim:

1. A method for unlocking a media case containing media therein following a checkout match and recordation phase of a checkout process for such media, such media case having an identification tag associated therewith, at least one movable magnetically sensitive element, and at least one locking pin therein, including:
detecting the presence of the media case;
aborting said method if the media case is no longer detected;
detecting the model of said media case;
reading the identification tag associated with such media and if the identification tag indicates a proper checkout match of the contained media then unlocking the media case but if the identification tag indicates lack of a proper checkout match of the contained media then leaving the media case is locked; and,
instructing a user about disposition of the media case.

2. The media case unlocking method of claim 1 further comprising:
said unlocking the media case including one of a vertical movement or a horizontal movement of a magnet into a position, said magnet pulling a locking pin and thus unlocking the media case.

3. The media case unlocking method of claim 1 further comprising:
said unlocking the media case including activating an electromagnet in a preset position, said electromagnet pulling a locking pin and thus unlocking the media case.

4. The media case unlocking method of claim 1 further comprising:
said detecting the media case including one of an infrared sensor or a mechanical switch.

5. The media case unlocking method of claim 1 further comprising:
said instructing a user including an illuminated annunciator panel, said panel indicating insertion of the media case, removal of the media case, or to wait via a lighted panel.

6. The media case unlocking method of claim 1 further comprising:
the media case having at least one color status indicator; and,
viewing the color status indicator and determining whether the media case may be unlocked in cooperation with said reading the identification tag.

7. The media case unlocking method of claim 1 further comprising:
said method communicating electronically to a separate host computer.

8. A method for unlocking a media case containing media therein during a checkout process for such media, such media case having at least one identification tag associated therewith, at least one movable magnetically sensitive element, and at least one locking pin therein, including:
detecting the presence of the media case;
aborting said method if the media case is no longer detected;
reading the identification tag associated with the media and forwarding information thereon to a computer;
determining by said computer if the information indicates the contained media is approved for checkout then unlocking said case but if the information indicates the contained media is not approved for checkout then leaving the identification tag as is and the media case as locked; and,
instructing a user about disposition of the media case.

9. The media case unlocking method of claim 8 further comprising:
said unlocking the media case including one of a vertical movement or a horizontal movement of a magnet into a position, said magnet pulling a locking pin and thus unlocking the media case.

10. The media case unlocking method of claim 8 further comprising:
said unlocking of the media case including activating an electromagnet in a preset position, said electromagnet pulling a locking pin and thus unlocking the media case.

11. The media case unlocking method of claim 8 further comprising:
said detecting of the media case including one of an infrared sensor or a mechanical switch.

12. The media case unlocking method of claim 8 further comprising:
said determining by said computer if the information indicates the contained media is approved for checkout then revising the information upon the identification tag as being checkout matched and unlocking the media case.

13. The media case unlocking method of claim 8 further comprising:
said instructing a user including an illuminated annunciator panel, said panel indicating insertion of the media case, removal of the media case, or to wait via a at least one light emitting diode.

14. The media case unlocking method of claim 8 further comprising:
the media case having at least one color status indicator; and,
viewing the color status indicator and determining whether the media case may be unlocked in cooperation with said reading of the identification tag.

15. The media case unlocking method of claim 8 further comprising:
said method communicating electronically to a separate host computer.

16. A system for providing media case unlocking during a secure checkout of media from a source, such as a library or a retail store, the media locating within a media case having a perimeter, two halves joining upon a living hinge, at least one of the halves having a strong magnet thereon, a carrier holding the strong magnet, the carrier moving upon a portion of the perimeter of the case opposite the hinge, the carrier including at least one colored indicator detectable outside the case, comprising:
a holder receiving the case opposite the hinge, said holder having a sensor detecting the presence of the case therein, a magnet position control proximate said holder, and a second sensor detecting whether the case is unlocked; and,
a controller in communication with said sensor, said magnet position control, and said second sensor, said controller connecting to an external host upon an electronic network, said controller operating an RFID transponder, and said controller selectively illuminating an annunciator panel to guide a user.

17. The media case unlocking system of claim 16 wherein said second sensor operates in the visible light spectrum.

18. The media case unlocking system of claim 17 wherein said second sensor detects green and red wavelength light.

19. The media case unlocking system of claim 16 wherein said controller regulates locking and unlocking of the case placed in said holder using information from said sensor, said magnet position control, and said second sensor so that no media is checked out in substitution for another media.

20. The media case unlocking system of claim 16 further comprising:
said second sensor detecting component wavelengths of light.

21. A media case unlocking system for controlling the unlocking of media cases for removal of media therefrom, the media cases having machine readable information tags therewith including thereon information regarding such media cases, the contents thereof, and the checkout status applicable to such media cases and the contents thereof, the media cases also having magnetically operable latching mechanisms for locking and unlocking the media cases, those media cases that are media cases that were presented during a checkout and match phase of a checkout process and whose unlocking is authorized being defined to be checkout matched media cases, such checkout matched media cases having specific information that was entered to the information tags thereof during a checkout match and recordation phase of a checkout procedure signifying that such media cases were presented during such checkout match and recordation phase of operation and that unlocking thereof is authorized, comprising
a media case unlocking apparatus having a channel in which a locked media case is positionable for unlocking and a magnet position control including a magnetic mechanism positionable adjacent the magnetically operable latching mechanism of a media case positioned in said channel to effect movement of the latching mechanism to unlock such media case,
a tag reader for reading the information on the information tag of a media case positioned in said channel of said unlocking apparatus,
a controller connected to receive the information read from the information tag and for determining from such information whether the media case positioned in said channel is a checkout matched media case,
said controller responsive to a determination that the media case positioned in the channel is a checkout matched media case to produce and provide to said magnet position control a signal to effect operation of said magnet position control to position said magnet adjacent the latching member of the media case to effect movement of said latching member and unlocking of the media case positioned in said channel.

22. The media case unlocking system of claim 21 further including a patron annunciator panel for providing to a patron, under control of said controller, information regarding the status at different times of the media case unlocking actions being taken by the media case unlocking system.

23. The media case unlocking system of claim 22 wherein the media checkout match and recording phase of the checkout process is affected by an entity having a host computer system, the media case unlocking system including a communications link for linking said controller to the host computer system.

24. The media case unlocking system of claim 21 wherein
said unlocking apparatus includes a first sensor for detecting the presence of a media case in said channel and for communicating said presence detection to said controller,
said controller is responsive to receipt of said presence detection to effect action by said tag reader to read the information on the information tag of the media case.

25. The media case unlocking system of claim 21 wherein
the media cases have movable locking bar mechanisms with associated spaced magnetic members along an edge of the media cases, differently colored indicia along the edge for signifying that the lock status of is the media case is either locked or unlocked, and a display portion along such locking bar at which one of such indicia is viewable dependent upon the position of the locking bar in a locked or unlocked position,
said unlocking apparatus has associated therewith an optical array comprising an infrared emitter and sensor and a movable color sensor array,
said infrared emitter and sensor operable to detect the presence of a media case in said channel and communicate said presence detection to said controller,
said movable color sensor array movably positionable under control of said controller following said presence detection to provide color sample signals to said controller,
said controller operable in response to receipt of said color sample signals to determine from stored information the media case type presented, the position of the display portion along the locking bar, and color of the indicia displayed thereat,
said controller operable upon such determination to determine from the information read from the information tag whether the media case positioned in said channel is a checkout matched media case,
said magnet positioning control including a pair of spaced magnetic elements configured to be coordinately positionable relative to the magnetic members associated with the locking bar mechanism,
said magnetic elements of said magnet positioning control movable under control of said controller after being positioned generally adjacent to the magnetic members associated with the locking bar mechanism to effect movement of such magnetic members and the locking bar mechanism to unlock the media case.

26. The media case unlocking system of claim 25 further including a patron annunciator panel for providing to a patron, under control of said controller, information regarding the status at different times of the media case unlocking actions being taken by the media case unlocking system.

27. The media case unlocking system of claim 26 wherein said movable color sensor array is operable under control of said controller following operation of said magnet position control unlocking the media case to provide color sample signals to said controller to confirm a change in colors of the displayed indicia.

28. The media case unlocking system of claim 27 wherein certain of the information provided to a patron is information indicating the lock status of the media case at different point in time.

29. The media case unlocking system of claim 25 wherein said infrared emitter and sensor is operable to emit a series of high energy pulses from whose interaction with the media case a determination can be made as to whether such media case has been inserted into said channel with the locking bar mechanism first.

30. The media case unlocking system of claim 25 wherein said controller is responsive to said color sample signals utilized to determine the media case type to also determine the background color of the media case.

32. The media case unlocking system of claim 25 wherein the differently colored indicia include one symbol with a predominant red color and another symbol with a predominant green color, which different colors are determinable by said controller from said color sample signals.
